(19) United States
(12) Patent Application Publication
(10) Pub. No.: US 2007/0263698 A1
(43) Pub. Date: Nov. 15, 2007

(54) Probe cover for ear thermometer

(76) Inventors: Kevin Lin, HsinChu (TW); Vincent Weng, HsinChu (TW); James Huang, HsinChu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/545,506

(22) Filed: Oct. 11, 2006

(30) Foreign Application Priority Data
May 9, 2006 (TW) 95116344

(51) Int. Cl. G01K 1/08

(52) U.S. Cl. 374/158

(57) ABSTRACT

The present invention discloses a probe cover for an ear thermometer, which comprises: a film cover and a base. The film cover has a cover window able to contact the probe window at the front end of the ear thermometer and a hollow cone able to contact the sidewall of the probe. The width of the cover window is greater than the width of the probe window. Thereby, the present invention can prevent the variation of infrared transmittance caused by the misarrangement and non-uniform thickness of the probe cover film disposed at the front of the probe window.

### BACKGROUND OF THE INVENTION

1. Field of the Invention

The present invention relates to a probe cover for an ear thermometer, particularly to a design, which can prevent the variation of the infrared transmittance of the probe cover film and avoid the error of body temperature measurement.

2. Description of the Related Art

Nowadays, it is very popular to measure the body temperature with an ear thermometer. However, the ear thermometer has to reach into the ear canal. For sake of hygiene, the probe of an ear thermometer is sleeved with a probe cover lest dirt and germs pollute the probe.

Refer to FIG. 1A, a diagram showing a conventional probe cover for an ear thermometer. As shown in FIG. 1A, the conventional probe cover 12 has a cover window 121 able to contact the probe window 14 of an ear thermometer and a cover sidewall 122 able to contact the probe casing. The width of the cover window 121 equals the width of the probe window 14. Refer to FIG. 1B. However, when the probe is sleeved with the probe cover 12, the cover window 121 is usually hard to exactly coincide with the probe window 14, i.e. the film covering the probe window 14 is not completely the film of the cover window 121 but partially the film of the cover sidewall 122. In such a case, the infrared light will pass a film with a non-uniform thickness. Thus, the result of temperature measurement will be inaccurate.

Accordingly, the present invention proposes a probe cover for an ear thermometer to overcome the abovementioned problem.

### SUMMARY OF THE INVENTION

The primary objective of the present invention is to provide a probe cover for an ear thermometer, which can be fast and precisely sleeved over the probe of an ear thermometer and can prevent the probe cover from being misarranged over the probe and can avoid the non-uniform thickness of the film covering the probe window, and whereby the body temperature can be accurately measured.

To achieve the abovementioned objective, the present invention proposes a probe cover for an ear thermometer, which comprises: a film cover and a base with a central opening, wherein the film cover has a cover window able to contact the probe window of the ear thermometer and a hollow cone able to surround the sidewall of the probe; the width of the cover window is greater than the width of the probe window so that the probe window can be covered by a larger film of the cover window; thereby, the personnel can be free from the conventional trouble that they have to check whether the cover window has exactly coincided with the probe window after they have installed the probe cover over the probe.

To enable the objective, technical contents, characteristics, and accomplishments of the present invention to be easily understood, the embodiments of the present invention are to be described in detail in cooperation with the attached drawings below.

### BRIEF DESCRIPTION OF THE DRAWINGS

FIG. 1A is a sectional view schematically showing that a conventional probe cover is installed to the probe of an ear thermometer.

FIG. 1B is a perspective view schematically showing the misarrangement of a conventional probe cover.

FIG. 2 is a perspective view schematically showing the probe cover for an ear thermometer according to the present invention.

FIG. 3 is a sectional view schematically showing the probe cover for an ear thermometer according to the present invention.

FIG. 4 is a perspective view schematically showing the probe cover sleeves a probe of an ear thermometer according to the present invention.

FIG. 5 is a sectional view schematically showing the probe cover sleeves a probe of an ear thermometer according to the present invention.

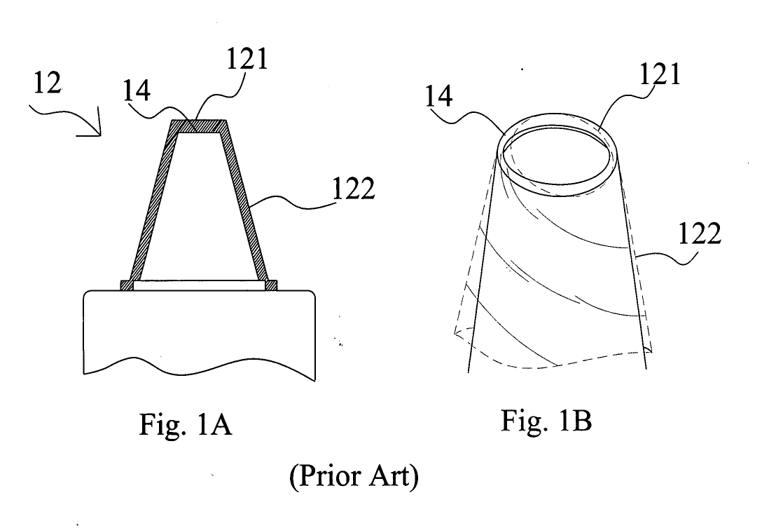

### DETAILED DESCRIPTION OF THE INVENTION

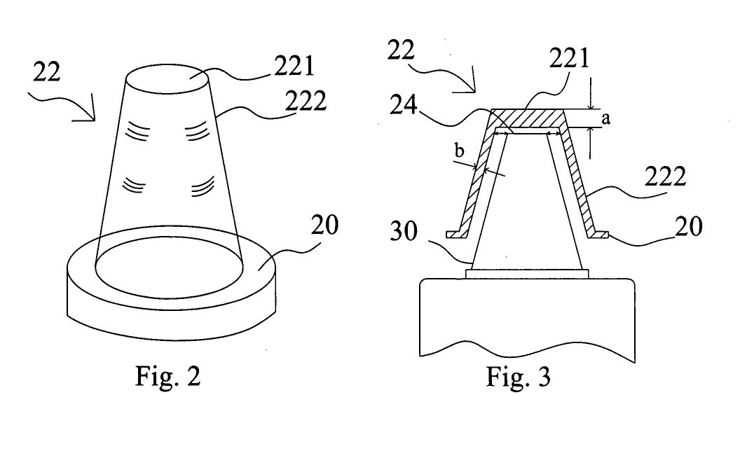

Refer to FIG. 2 and FIG. 3, respectively a perspective view and a sectional view schematically showing the probe cover for an ear thermometer according to the present invention. As shown in the drawings, the probe cover for an ear thermometer of the present invention comprises: a base 20 having a central opening and a film cover 22 having a cover window 221 and a hollow cone 222. The hollow cone 222 extends from the cover window 221 to the central opening of the base 20 and joins the base 20. The base 20 is to be installed to the probe structure 30 of the ear thermometer to encircle the probe structure 30 fixedly. The cover window 221 is to contact the probe window 24 of the probe structure, and the hollow cone 222 is to surround the sidewall of the probe. The base 20 may be made of a more rigid plastic material, and the film cover 22 may be made of an infrared-permeable plastic material.

As shown in FIG. 3, the width of the cover window 221 is at least 0.2 mm greater than the width of the probe window 24. Cooperating with ths base 20, the thickness of the hollow cone 222 is gradually thinned toward the bottom of the probe structure 30. Thus, the thickness b of the film of the hollow cone 222 is smaller than the thickness a of the film of the cover window 221.

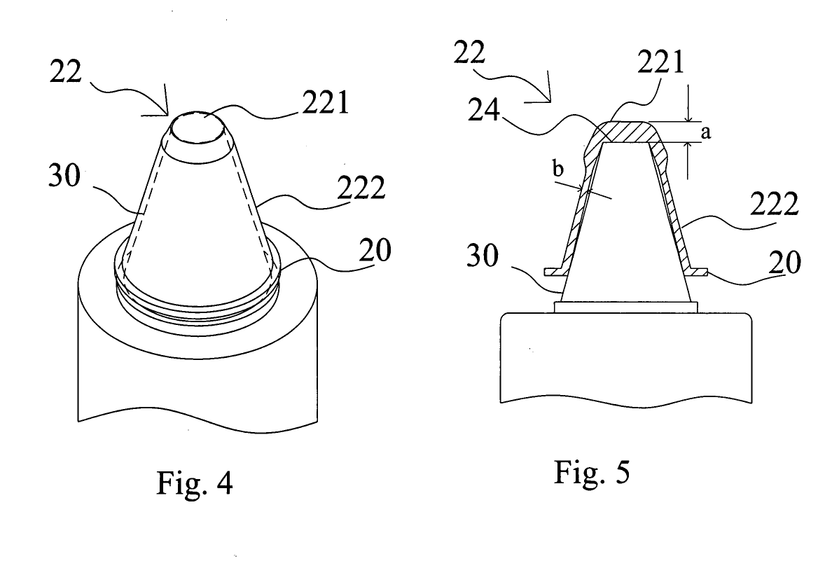

Refer to FIG. 4 and FIG. 5 respectively a perspective view and a sectional view schematically showing the film cover sleeves the probe. When the film cover 22 sleeves the probe, the redundant width of the cover window 221 will be pulled to contact the sidewall of the probe. Thus, the film covering the probe window 24 all belongs to the cover window 221, and the film covering the probe window 24 is free from the non-uniformity of the film thickness.

The present invention is characterized in that the width of the cover window is greater than the width of the probe window. Thereby, after the personnel have installed the probe cover over the probe, they can be free from the conventional trouble that they have to check whether the cover window has exactly coincided with the probe window. Thus, the probe cover of the present invention not only can be fast and precisely installed to the probe of an ear thermometer but also can make the film covering the probe window all belong to the cover window. Therefore, the present invention can promote the accuracy of body temperature measurement.

Those described above are only the preferred embodiments to clarify the technical contents and characteristics of the present invention to enable the persons skilled in the art to understand, make and use the present invention. However, it is not intended to limit the scope of the present invention. Any modification and variation according to the spirit of the present invention is to be also included within the scope of the claims of the present invention.

What is claimed is:

1. A probe cover for an ear thermometer, used to sleeve the probe of an ear thermometer having a probe window, and comprising: a base having a central opening and a film cover having a cover window and a hollow cone extending from said cover window to said central opening and joining said base, and characterized in that a width of said cover window is greater than a width of said probe window of said ear thermometer.

2. The probe cover for an ear thermometer according to claim 1, wherein said base is made of rigid plastic material.

3. The probe cover for an ear thermometer according to claim 1, wherein said base is made of infrared-permeable plastic material.

4. The probe cover for an ear thermometer according to claim 1, wherein said cover window and said hollow cone are fabricated into a one-piece element.

5. The probe cover for an ear thermometer according to claim 1, wherein a thickness of the film of said hollow cone is smaller than a thickness of the film of said cover window.

6. The probe cover for an ear thermometer according to claim 1, wherein said width of said cover window is about at least 0.2 mm greater than said width of said probe window.

7. The probe cover for an ear thermometer according to claim 1, wherein said base can be put on the probe structure of said ear thermometer and encircle said probe structure of said ear thermometer fixedly.
